(19) United States
(12) Patent Application Publication
(10) Pub. No.: US 2024/0367519 A1
(43) Pub. Date: Nov. 7, 2024

(54) Method for Generating and Outputting an Operating Signal in a Vehicle as well as Computer Program Product

(71) Applicant: Bayerische Motoren Werke Aktiengesellschaft, Muenchen (DE)

(72) Inventor: Daniel Killian, Röhrmoos (DE)

(21) Appl. No.: 18/646,535

(22) Filed: Apr. 25, 2024

(30) Foreign Application Priority Data
May 3, 2023 (DE) 10 2023 111 406.9

(51) Int. Cl. B60K 35/10; B60K 35/25; B60W 50/16; B62D 5/00

(52) U.S. Cl. CPC B60K 35/10; B60K 35/25; B60W 50/16; B62D 5/005; B60K 2360/113; B60K 2360/126

(57) ABSTRACT

A method generates and outputs an operating signal in a vehicle with a steering wheel. The method includes the steps of operating the vehicle at a standstill or in an autonomous driving mode. The method also includes detecting a steering wheel angle and generating and outputting the operating signal. The operating signal controls a vehicle component, or can be used for a menu navigation of an on-board computer based on the detected steering wheel angle.

This application claims priority of German patent application no. 10 2023 111 406.9, filed on May 3, 2023, which is incorporated herein by reference in its entirety.

### TECHNICAL FIELD

Exemplary embodiments relate to a method for generating and outputting an operating signal in a vehicle with a steering wheel. The operating signal can be used to carry out vehicle functions. Other exemplary embodiments relate to a computer program product with program code for carrying out the method.

### BACKGROUND

In modern motor vehicles, more and more functions are being introduced that require input elements to operate and control the functions. Often, extensive infotainment systems are also provided with a large number of menu items that the user can select.

Specially designed operating elements can be provided for various functions. For example, rotary pushbuttons are known for controlling menu navigation, with which the menu entries can be controlled and selected.

Providing operating elements, such as buttons or toggle switches, with fixed assignment to control a specific function, can have the advantage that the user of the vehicle knows exactly where the button is that allows them to control the function with regular use. For example, due to the good haptic properties of a button, the user does not need to look at the button when operating. On the other hand, it can be difficult to provide a large number of buttons in the vehicle in terms of space, and this can also result in higher costs.

Another way to operate vehicle functions of any kind (for example menu navigation and/or control of vehicle components such as windows, doors or seat adjustment) is to use digital displays, for example with a touch function. However, selecting functions on a touchscreen can have drawbacks, especially while the vehicle is travelling.

### SUMMARY

It is an object of the present disclosure to provide improved concepts for the operation of vehicle functions or menu navigation in vehicles.

This object is achieved according to the subject-matter of the independent claims. Further advantageous embodiments are described in the dependent claims, the following description and in connection with the figures.

Accordingly, a method for generating and outputting an operating signal in a vehicle with a steering wheel is proposed. The method includes operating the vehicle at a standstill or in an autonomous driving mode (for example from Level IV or higher) as well as detecting a steering wheel angle of the steering wheel. In addition, the operating signal for control of a vehicle component or for menu navigation of an on-board computer is generated and output based on the detected steering wheel angle.

The operating signal can be used to control the vehicle component or to operate the menu navigation. Thus operation or control of vehicle functions or menu navigation can advantageously be carried out using the steering wheel. An operating signal for individually definable functions (for example by a user of the vehicle) or predetermined functions, for example, can be generated using the steering wheel already available in the vehicle. This is possible because, for example, when the vehicle is at a standstill, the steering wheel is not needed for steering and can therefore be used for alternative operating inputs. The advantage of the concept of a multifunction steering wheel with several additional input buttons can result in a smaller number of buttons required on the steering wheel, but also in other places in the vehicle interior, as a change in the steering angle is available as an additional input parameter. For example, buttons on the steering wheel for navigating back and forth in a menu can be omitted.

According to one aspect, it is provided that the vehicle used in accordance with the method will be equipped with a steer-by-wire steering system and that a steering movement of the wheels of the vehicle will be decoupled from a movement of the steering wheel. In automotive engineering, steer-by-wire refers to a system in which a steering command from a steering wheel sensor, which records the steering angle, among other things, is transmitted exclusively electrically via one or more control units to the electromechanical actuator that executes the steering command. With steer-by-wire, there is no mechanical connection between the steering wheel and the steered wheels. As a result, in a signal-decoupled mode the steering wheel can be turned without affecting the actual steering angle of the wheels. Decoupling the movement of the steering wheel from a movement of the tires can make it possible to use the steering angle of the steering wheel, for example during a drive in highly autonomous mode, as an input parameter for another vehicle function. Furthermore, decoupling has the advantage, for example when stationary, that unnecessary tire wear caused by tires steering at a standstill can be avoided.

According to one aspect, it is provided that, using an actuator on the steering wheel, detent marks will be inserted into the rotational movement at predetermined steering angles, wherein a corresponding operating signal will be generated and output when a detent mark is passed. A detent mark for the steering movement can be implemented, for example, by a slight counter-pressure or counter-torque generated by the actuator. This allows the user to receive improved haptic feedback on their user input. For example, it can be provided that an incremental change of the operating signal takes place with each detent mark passed or that a new operating signal is issued in each case. For example, a next menu item can be selected for each detent mark. This allows the user to skip a certain number of menu entries without having to look at the menu navigation, as he receives haptic feedback on the number of menu entries. For example, detent marks can be inserted at regular angular intervals (for example every 5° or every 10° or every) 15°. Alternatively, detent marks may have smaller angular distances from each other in angular ranges farther away from a center position of the steering wheel than in an angular range closer to the center position. This can enable an accelerated run through the menu in the case of a plurality of menu entries.

According to one aspect, when an end of the menu navigation or an adjustment range of the vehicle component is reached by turning the steering wheel in a first direction, an actuator of the steering wheel prevents a further rotation in the first direction by adjusting a counterforce. This is an advantageous way to convey to the user through haptic feedback that there are no more menu items. Depending on the direction of rotation, the next rotation can be prevented for a first or last menu entry, both of which can define an end of the menu entries.

According to one aspect, it is provided that the detected steering wheel angle will have a predetermined steering pattern. For example, a steering pattern can include a movement of the steering wheel defined against time. In other words, a change in the steering angle against time during a predetermined period of time can be detected and recorded and stored by the user. For example, when detecting the steering wheel angle, a sequence of movements of the steering wheel can be analyzed, such as turning the steering wheel twice in succession, alternately to the left and right. The steering pattern can also be referred to as a steering gesture.

According to one aspect, it is provided that the predetermined steering pattern is or will be assigned to a predetermined operating function of a vehicle component (for example individually by the user). According to another aspect, in addition to gestures on both sides of the steering wheel, gestures from the center of the steering wheel can also be distinguished. The latter can be used intuitively for side-related vehicle functions. For example, a steering pattern “turn the steering wheel completely to the right” (i.e. complete rotation of the steering angle) can be assigned to the function “open the right side window completely”. Steering patterns can have different characteristics example fast or slow movement of the steering wheel; for example large or small steering angle), so that different steering patterns can be easily differentiated. Thus, by using a plurality of steering patterns it is possible to operate a corresponding number of vehicle functions with the one steering wheel. For example, the vehicle function can be activated (for example opening the window) when the steering pattern is entered for the first time and deactivated again (for example closing the window) when the second input is subsequently made. The use of steering patterns to control vehicle functions can be particularly advantageous for less frequently used vehicle functions for which the use of separate buttons or controls is not worthwhile, wherein the proposed operation by steering wheel can still allow for quick operation of these vehicle functions.

According to one aspect, it is provided that the method also includes the recording and storage of a steering pattern that a user of the vehicle enters or generates by operating the steering wheel. Furthermore, assigning the stored steering pattern to an operating signal as a predetermined steering pattern is provided. The user can thus generate individual steering patterns and later use them to control, activate and/or deactivate vehicle functions defined by him and assigned to the steering pattern. For example, a configuration mode can be provided in the vehicle in which the user can assign individually created steering patterns to specific control commands.

According to one aspect, it is provided that the steering pattern is represented graphically (for example, the predetermined steering pattern; for example, the steering wheel movement entered by the user in the configuration mode to select at least one steering pattern). For example, in the configuration mode, the steering angles of the steering wheel movement of the last 5 seconds or the last 10 seconds can be displayed in a time profile. The start command for recording can be predefined by the user, for example, by means of the input button on the steering wheel (as in the case of voice input) or in the control panel of the display screen. For example, the user can then select a section of the graphically displayed steering pattern and save it as a predetermined steering pattern.

According to one aspect, it is provided that when detecting the steering wheel angle, a tolerance range is taken into account in terms of time and/or steering angle in order to recognize the predetermined steering pattern. For example, the steering pattern may involve moving the steering wheel back and forth at a predetermined frequency of 3 Hz, and the tolerance range may be +/−20%, so that even if there is a slight deviation from the exact frequency of the steering pattern, the corresponding steering pattern can still be recognized. The same can apply to the steering angle, i.e. the amplitude of the steering angle. For example, the tolerance range can be less than 30% (or less than 20% or less than 10%) and/or greater than 5% (or greater than 10%). In accordance with another aspect in this context, it is provided that the logic of the on-board computer compares newly entered steering gestures with the existing gestures, taking into account the tolerance fields, and informs the user if certain gestures are too close to each other in terms of their distinction.

Another aspect concerns a computer program product or non-volatile storage medium with a program code for performing the method described above or below when the computer program is executed on a processor, a computer, or programmable hardware. Such a program can be advantageously executed on an on-board computer or a backend (for example a server or a cloud service linked to the vehicle and/or a mobile device of the vehicle user) in order to carry out the proposed method and thus enable the use of the steering wheel as an input element for controlling a menu navigation an or individually adjustable vehicle function as an alternative to steering the vehicle. An advantageous aspect of implementation via cloud-based services is that the user can easily transfer his or her own steering profiles, even when changing vehicles, without having to retrain them in the vehicle.

### BRIEF DESCRIPTION OF THE FIGURES

Exemplary embodiments are explained in more detail below with reference to the enclosed figures. In the figures:

FIG. 1 shows a flow diagram of a method for generating and outputting an operating signal;

FIG. 2 shows a schematic example of a steering wheel used as an input element for menu navigation in a predetermined driving mode; and

FIG. 3 shows a schematic example of entering and selecting steering patterns that can be used to activate individually assigned vehicle functions.

### DESCRIPTION

Various exemplary embodiments are now described in more detail with reference to the enclosed drawings, in which some exemplary embodiments are represented. In the figures, the thickness dimensions of lines, layers and/or regions may be exaggerated for the sake of clarity. In the following description of the attached figures, which show only a few exemplary embodiments, the same reference marks can refer to the same or comparable components.

An element that is referred to as “connected” or “coupled” to another element, may be directly connected or coupled to the other element, or there may be intervening elements. Unless otherwise defined, all terms used herein (including technical and scientific terms) shall have the same meaning as those given to them by an average person skilled in the field to which the exemplary embodiments belong.

With the introduction of electromechanical steering systems (Electric Power Steering, EPS) in modern motor vehicles, the sensor technology required for control has been expanded. A further step in the development of steering systems concerns the complete mechanical separation between the steering wheel and the chassis. These systems are known as “steer-by-wire” steering systems. This disclosure describes concepts that take advantage of the special characteristics of a steer-by-wire steering system. With regard to certain aspects, it is also possible to transfer the concepts to conventional EPS. Both systems are equipped with sensors that can be used to detect the angular position of the steering wheel at any time during operation (for example the steering wheel angle).

Due to the further development of modern display systems, the variety of display options in the vehicle has steadily increased in recent years. For example, fully digital instrument clusters are realized by a display behind the steering wheel, which can also include all multimedia applications by extending it to the area of the center console. Furthermore, by means of head-up displays the windshield or a virtual area in front of or behind it can be used for display, for example. Concepts that can advantageously combine the possibilities of steer-by-wire steering wheels and digital displays are described below.

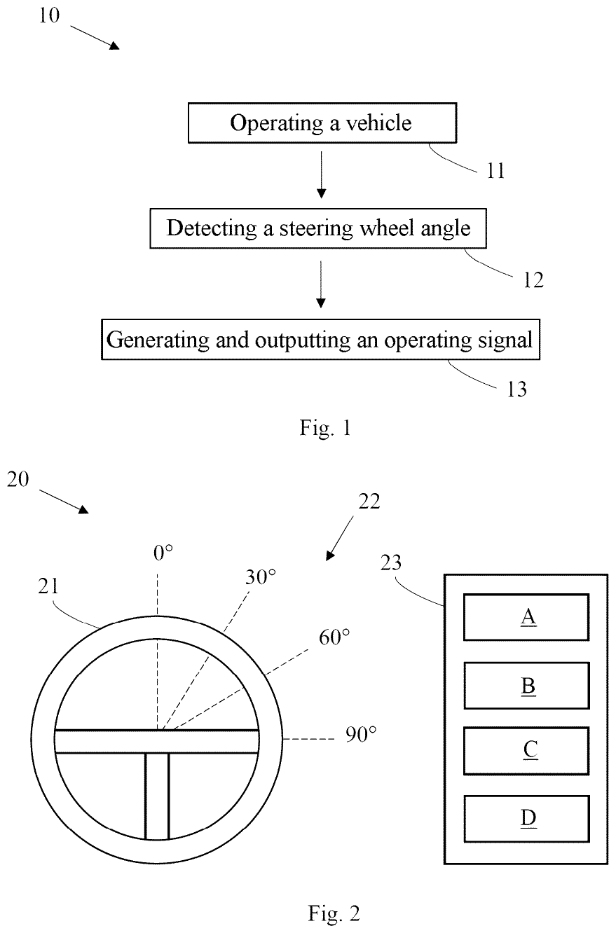

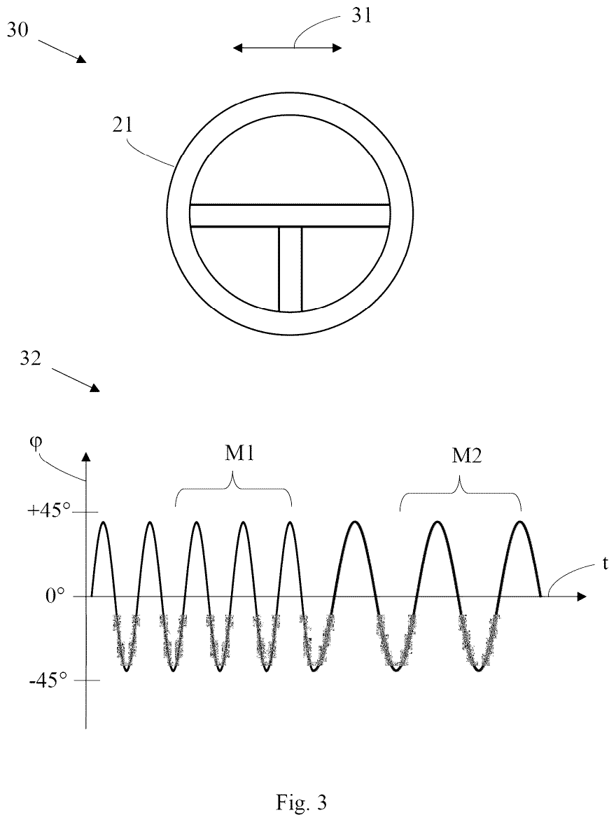

FIG. 1 shows a method 10 for generating and outputting an operating signal in a vehicle with a steering wheel (see for example the steering wheel schematically shown in FIG. 2 and FIG. 3). The method 10 includes the steps: operation 11 of the vehicle at a standstill or in an autonomous driving mode; detection 12 of a steering wheel angle; and generation and output 13 of the operating signal for controlling a vehicle component or for menu navigation of an on-board computer based on the detected 12 steering wheel angle. The operating signal generated in accordance with the method 10 can be used, for example, to control a menu navigation (see example in FIG. 2) or to control vehicle functions that do not involve steering the vehicle tires. For example, the method 10 can also be used in conjunction with the input and recognition of steering patterns (see example in FIG. 3), so that different functions can be controlled by means of different, defined steering movements.

FIG. 2 shows a schematic example 20 of a steering wheel 21 that is used in a predetermined driving mode (for example standstill or highly automated driving) as an input element for navigation a menu 23. It is schematically shown that different steering angles can be achieved via a steering wheel angle 22 (for example 0° in the center position; 30°, 60° and 90° with the steering wheel angle 22 to the right).

In the case of the steering angles shown (for example at an angular separation of 30° in each case), it can be provided that a detent mark is inserted by means of a force feedback actuator of the steering wheel 21, for example the user can feel a slight counter pressure when exceeding the respective steering angle, which must be overcome in order to continue turning. If a detent mark is passed, it can be provided to change the selected menu item A, B, C, D by changing the operating signal accordingly (for example the output of an operating signal “one step further” or an incremental change of the operating signal). For example, when turning the steering wheel to the right from 0° via the 30° detent mark, it is possible to switch from the first menu item A to the second menu item B.

The menu list can be limited by the two end entries A, D. When an end A, D of the menu navigation is reached (for example end entry A or end entry D), the force feedback actuator of the steering wheel 21 can prevent the steering wheel 21 from turning further by generating a counterforce, so that the user can be alerted that there are no more menu entries.

One aspect of the proposed concepts is to use the movement of the steering wheel as an additional input/control element for an immersive operating concept. This can be done in situations where the driver is not currently actively or manually participating in the driving process (for example in a driving mode with automated steering). For example, the method 10 can be performed in a parking mode or residential mode (stationary) of the vehicle, or in an automated driving mode (for example with Level 4 or higher). Steer-by-wire technology makes it possible to use the steering wheel differently both when stationary and during autonomous driving y decoupling steering wheel movement from vehicle steering movement.

Examples of applications for the use of the steering wheel as an input means for alternative functions to the steering of the vehicle are: —scrolling through a selected display menu analogous to the rotational motion of a rotary pushbutton; —intuitive switching between menu tiles or widgets in the display or head-up display, for example in extended head-up displays; —control of the volume of the entertainment system analogous to a volume wheel in the Hi-Fi area; —zoom function in map representations; —applications that, from an ergonomic point of view, can be implemented more suitably with (for example analogue, continuous) rotary movement than with (for example digital, discrete) inputs.

As a supplement to a complete input concept, a minimum set of input keys on the steering wheel such as “Enter” and “Escape” for “vertical” navigation between the menu functions (for example menu levels) is advantageous. Coupling with the voice function, the button of which can already be located on the steering wheel anyway, can be extended to a holistically immersive display-operating concept with the help of the steering wheel.

The implementation of the proposed concept with a steer-by-wire steering system can be particularly advantageous because, on the one hand, the rotational movement of the steering wheel is limited in any direction without a mechanical stop, and on the other hand, because the force required to operate in this operating mode can be very low. With regard to the latter, another aspect of the disclosure is, as already mentioned, that specific detent marks can be realized via a force feedback actuator of the by-wire steering wheel, so that the graphical menu structure of the display unit can also be haptically reflected in the operation. In addition, a virtual end stop can also be realized via a counter force with the help of this actuator, for example when the end of a scrolling or navigation range is reached.

Further details and aspects are mentioned in connection with the exemplary embodiments described above or below. The exemplary embodiment shown in FIG. 2 may have one or more optional additional features corresponding to one or more aspects mentioned in connection with the proposed concept or with one or more exemplary embodiments described above (for example FIG. 1) or below (for example FIG. 3).

FIG. 3 shows a schematic example 30 of an input and possible selection of steering patterns M1, M2, which can be used to activate individually assigned vehicle functions.

According to the example 30, it is provided that a schematically represented steering movement 31 of the steering wheel 21 (here, for example, alternately to the right and left) is displayed to the user in a graphical representation 32 (for example on a vehicle display or a display of a mobile device of the user coupled to the vehicle). The steering movement 31 can be represented in the form of a steering angle φ against a time axis t. In the example 30, smooth steering movements 31 with different frequencies are shown, wherein a first steering pattern M1 is selected from a first region of the representation 32 that has a higher frequency than a second region of the representation 32 from which a second steering pattern M2 is selected. Alternatively, a steering pattern can be selected that has a frequency change (for example a transition from high to low steering frequency). The region that is to define a steering pattern M1, M2 can be advantageously selected by the user after entering it in the form of the steering movement 31, so that there is a particularly simple way for the user to define steering patterns M1, M2.

By linking the steering system to the display/operating concept, it is possible, for example, to graphically display the steering wheel angle variation over time (see representation 32). One aspect of the disclosure is to provide the user with an application (app) in series manufacture or subsequently digitally, which allows him to record and store a certain steering wheel rotation sequence, i.e. a movement pattern (for example a steering pattern M1, M2). This can happen when the vehicle is stationary or—in the case of steer-by-wire steering systems—also in autonomous driving mode. These movement patterns can then be assigned to a specific vehicle function (for example one that is not relevant to driving safety in autonomous operation).

As an example, a classic sinusoidal curve is shown (cf. the two steering patterns M1, M2 shown), which can be recorded by the deflection or steering movement 31 of the steering wheel 21 from the center position (steering wheel angle 22 at 0°, see FIG. 2) first to the right, then with approximately the same deflection to the left. After saving and assigning the steering pattern, such a sequence can be used to control individually defined vehicle functions, for example, whose buttons are more likely to be located in the peripheral control area, such as tailgate operation.

As a further example, excitation patterns defined on one side from the center position can also be used to intuitively assign functions that match the corresponding side of the vehicle. An example would be the operation of the left and right window lifters by means of a corresponding steering wheel gesture to the left (negative steering angle j) or to the right (positive steering angle q).

The method opens up the possibility of using direction-dependent steering patterns. For example, a sinusoidal movement can only occur in the positive steering angle range (not shown), so that the steering pattern (for example a third steering pattern that is not shown) is generated with movements exclusively to the right of the center orientation of the steering wheel and can thus intuitively control a function on the right side of the vehicle, for example. In an analogy to the steering pattern M1 shown in FIG. 3, the graphical representation of the right-hand steering pattern on the ordinate would be shifted in a positive direction, so that it has only sine waves above the zero line. With such a steering pattern, you could now open the window on the right, for example.

Similar for example to character recognition for a touch input, it is provided that the steering movement patterns also allow a certain tolerance for correct interpretation for a reliable implementation (for example detection 12 of the steering pattern) (for example with regard to steering angle j and frequency; for example a detection with a tolerance range of less than +/−10% or +/−5% compared to the parameters of the stored steering pattern M1, M2 can be possible). When creating a new steering pattern, the user can be alerted if a new steering pattern is too similar to an existing steering pattern.

FIG. 3 shows a schematic recording function for storing steering patterns (“recording function”). A visual display of the steering profile is provided by displaying the steering angle j against time t. For example, the steering movements 31 of the last 10 seconds can be displayed (or the last 20 seconds or 30 seconds). It is possible to select the intended steering pattern (for example desired steering pattern) by selecting from the displayed time graph. For example, in the example 30 shown, the user can select two sections and thus select and save a first steering pattern M1 and a second steering pattern M2. Subsequently, the control of a first function can be assigned to the first steering pattern M1 and the control of a second function to the second steering pattern M2. Thus, for example, the first function can be performed when moving the steering wheel 21 back and forth at a first frequency and the second function when moving the steering wheel 21 back and forth at a second, lower frequency.

For example, a frequency threshold can be defined between the first and second frequencies so that the first function can be activated with a steering movement 31 with a frequency above the frequency threshold and the second function with a steering movement 31 with a frequency below the frequency threshold. As a result, a high detection tolerance can be achieved when recognizing the steering pattern entered by the user.

For example, when entering the steering pattern, the insertion of detent marks at predetermined steering angles can also be used. As a result, a steering amplitude or steering angle can be better recognized by the user and a reliable input of different steering angles can be made. For example, a third steering pattern (not shown) may contain smaller steering angles than a fourth steering pattern (not shown). For example, for the input of the third steering pattern, a deflection of the steering wheel can only be provided up to a first detent mark, while for the input of the fourth steering pattern, a deflection of the steering wheel 21 to a second or third detent mark can be provided. In this way, specially defined input of steering patterns can be made possible for the user.

Further details and aspects are mentioned in connection with the exemplary embodiments described above or below. The exemplary embodiment shown in FIG. 3 may have one or more optional additional features corresponding to one or more aspects mentioned in connection with the proposed concept or with one or more exemplary embodiments described above (for example FIG. 1-2) or below.

Aspects of the disclosure concern extended functions for a multifunction steering wheel. In particular, it is suggested to use individual steering gestures, for example steering patterns. A specific steering wheel rotation sequence, i.e. a movement pattern of the steering wheel, can be recorded and stored. These movement patterns can then be assigned to a specific vehicle function. The steering movement of the steering wheel can therefore be used, as an alternative to influencing a steering movement of the vehicle tires, for the control of other functions of the vehicle or for menu navigation in the infotainment system.

1. A method for generating and outputting an operating signal in a vehicle with a steering wheel, the method comprising:
operating the vehicle at a standstill or in an autonomous driving mode;
detecting a steering wheel angle; and
generating and outputting the operating signal for control of a vehicle component or for a menu navigation of an on-board computer based at least in part on the detected steering wheel angle.

2. The method according to claim 1,
wherein the vehicle used in accordance with method is equipped with a steer-by-wire steering system, and
wherein a steering movement of the vehicle tires is decoupled from a steering movement of the steering wheel.

3. The method according to claim 1,
wherein, when using an actuator of the steering wheel, at predetermined angles of the steering wheel angle detent marks are inserted into the steering movement as haptic feedback,
wherein an operating signal is generated and output when a detent mark is passed.

4. The method according to claim 3,
wherein, when an end of the menu navigation or of a setting range of the vehicle component is reached by the steering movement of the steering wheel in a first direction, an actuator of the steering wheel prevents further rotation in the first direction by setting a counterforce to the steering movement.

5. The method according to claim 1,
wherein, when an end of the menu navigation or of a setting range of the vehicle component is reached by the steering movement of the steering wheel in a first direction, an actuator of the steering wheel prevents further rotation in the first direction by setting a counterforce to the steering movement.

6. The method according to claim 1,
wherein the detected steering wheel angle is a part of a predetermined steering pattern.

7. The method according to claim 6,
wherein the predetermined steering pattern is assigned to a predetermined operating function of a vehicle component.

8. The method according to claim 7, the method further comprising:
detecting and storing a steering pattern that a user of the vehicle generates by a steering movement of the steering wheel; and
assigning the stored steering pattern as the predetermined steering pattern of the predetermined operating function of the vehicle component.

9. The method according to claim 8, further comprising providing a graphical representation of the steering pattern as an output.

10. The method according to claim 7, the method further comprising:
detecting and storing a steering pattern that a user of the vehicle generates by a steering movement of the steering wheel; and
assigning the stored steering pattern as a predetermined steering pattern to an operating signal.

11. The method according to claim 10, further comprising providing a graphical representation of the steering pattern as an output.

12. The method according to claim 6, the method further comprising:
detecting and storing a steering pattern that a user of the vehicle generates by a steering movement of the steering wheel; and
assigning the stored steering pattern as a predetermined steering pattern to an operating signal.

13. The method according to claim 6, further comprising recognizing the predetermined steering pattern based at least in part on the detected steering angle.

14. The method according to claim 13, wherein recognizing the predetermined steering pattern further comprises taking into account a tolerance range in terms of time and/or steering angle.

15. The method according to claim 13,
wherein the vehicle used in accordance with method is equipped with a steer-by-wire steering system, and
wherein a steering movement of the vehicle tires is decoupled from a steering movement of the steering wheel.

16. The method according to claim 13,
wherein, when using an actuator of the steering wheel, at predetermined angles of the steering wheel angle detent marks are inserted into the steering movement as haptic feedback,
wherein an operating signal is generated and output when a detent mark is passed.

17. The method according to claim 16,
wherein, when using an actuator of the steering wheel, at predetermined angles of the steering wheel angle detent marks are inserted into the steering movement as haptic feedback,
wherein an operating signal is generated and output when a detent mark is passed.

18. The method according to claim 6,
wherein, when an end of the menu navigation or of a setting range of the vehicle component is reached by the steering movement of the steering wheel in a first direction, an actuator of the steering wheel prevents further rotation in the first direction by setting a counterforce to the steering movement.

19. A non-transitory storage medium containing program code for performing the method according to claim 1 when the program code is executed on a processor, a computer, or programmable hardware.
